(19) United States
(12) Patent Application Publication
(10) Pub. No.: US 2025/0103811 A1
(43) Pub. Date: Mar. 27, 2025

(54) SYSTEMS AND METHODS FOR CONTENT ANALYSIS

(71) Applicant: VERB PHRASE INC., St. Albert (CA)

(72) Inventor: Sean Riley, Ottawa (CA)

(21) Appl. No.: 18/729,458

(22) PCT Filed: Jan. 19, 2023
(86) PCT No.: PCT/CA2023/050055

§ 371 Date: Jul. 16, 2024

Related U.S. Application Data
(60) Provisional application No. 63/301,460, filed on Jan. 20, 2022.

(51) Int. Cl. G06F 40/284; G06F 16/9538; G06F 40/30

(52) U.S. Cl. CPC G06F 40/284; G06F 16/9538; G06F 40/30

(57) ABSTRACT

Systems and methods for content analysis are disclosed that receive content and compute a rhetoric vector comprising one or more dimensions each representative of a rhetoric aspect of a language structure of the content. The rhetoric vector is classified using a trained classifier to determine whether a content advisory should be associated with the content.

### CROSS-REFERENCE TO RELATED APPLICATIONS

This application claims priority to U.S. Patent Application No. 63/301,460, filed on Jan. 20, 2022, the entire contents of which is incorporated by reference herein for all purposes.

### TECHNICAL FIELD

The present disclosure relates to analyzing content, and in particular to analyzing content for use in determining whether to generate advisories about the content.

### BACKGROUND

There are a few branches of Artificial Intelligence (AI) used to analyze content, such as hate speech detection, fake news detection, argument mining, and rhetorical figure detection, each of which is briefly described below.

### Hate Speech Detection

In response to the growing need for automated moderation tools, researchers have developed a variety of neural network approaches to detect the presence of hate speech in text. These methods take a supervised learning approach to the problem whereby labelled training data is fed into a classifier that learns how to identify whether or not a text is liable to contain hate speech. The type of classifier used in these methods varies, but many use some sort of neural network that encodes knowledge within connection weights between populations of artificial neurons (Beddiar, D. R., Jahan, M. S., and Oussalah, M. (2021). Data expansion using back translation and paraphrasing for hate speech detection. Online Social Networks and Media, 24:100-153; Ding, Y., Zhou, X., and Zhang, X. (2019). Ynu dyx at semeval-2019 task 5: A stacked bigru model based on capsule network in detection of hate. In Proceedings of the 13th International Workshop on Semantic Evaluation, pages 535-539; Mozafari, M., Farahbakhsh, R., and Crespi, N. (2020). Hate speech detection and racial bias mitigation in social media based on bert model. PLOS One, 15(8): e0237861; and Nozza, D. (2021). Exposing the limits of zero-shot cross-lingual hate speech detection. In Proceedings of the 59th Annual Meeting of the Association for Computational Linguistics and the 11th International Joint Conference on Natural Language Processing (Volume 2: Short Papers), pages 907-914.). This type of subsymbolic representation can be very powerful, but also produces a “black box,” which can present challenges in understanding how and why a network makes a particular decision (e.g., labelling a piece of content as containing hate speech).

### Fake News Detection

Much like hate speech detection, fake news detection draws heavily on neural networks and semantic processing to determine if a piece of content contains “fake news”. However, instead of training the model on positive and negative examples of hate speech, they train on positive and negative examples of fake news. These networks can vary in their structure (Kaliyar, R. K., Goswami, A., Narang, P., and Sinha, S. (2020). Fndnet-a deep convolutional neural network for fake news detection. Cognitive Systems Research, 61:32-44; Zhang, J., Dong, B., and Philip, S. Y. (2020). Fakedetector: Effective fake news detection with deep diffusive neural network. In 2020 IEEE 36th International Conference on Data Engineering (ICDE), pages 1826-1829. IEEE), but again they depend on subsymbolic forms of information processing.

### Argument Mining

In the case of argument mining, automated systems attempt to extract types/forms of argument and/or reasoning from text, and make inferences about why the authors take the positions they do. In one such model, Goudas et al. (Goudas, T., Louizos, C., Petasis, G., and Karkaletsis, V. (2014). Argument extraction from news, blogs, and social media. In Hellenic Conference on Artificial Intelligence, pages 287-299. Springer.) took a two-step approach whereby they first used a machine learning classifier to determine if a sentence contains an argument (based of a variety of features, such as the number of commas and the number of connectives in the sentence), then used a conditional random field model to isolate the text segments corresponding to the argument's premises and claims. Another model by Garten et al. (Garten, J., Boghrati, R., Hoover, J., Johnson, K. M., and Dehghani, M. (2016). Morality between the lines: Detecting moral sentiment in text. In Proceedings of IJCAI 2016 Workshop on Computational Modeling of Attitudes) took a hybrid embedding plus dictionary approach to identifying moral rhetoric. Using a dataset of tweets, the authors create two document vectors: one for each tweet, and one for a dictionary of known moral terms. The document vector for each tweet was then compared against the document vector for the dictionary, generating a metric of moral rhetoric/argumentation for said tweet. Other attempts at mining have deployed custom parsers that look to identify and label relevant segments of text. One such model can be found in the work of Palau and Moens (Palau, R. M. and Moens, M.-F. (2009). Argumentation mining: the detection, classification and structure of arguments in text. In Proceedings of the 12th International Conference on Artificial Intelligence and Law, pages 98-107), who used a context-free grammar to generate logical parses of texts, then applied a set of production rules to said parses so as to identify the text's argument structure. Similarly, Marcu, (D. (2000). The rhetorical parsing of unrestricted texts: A surface-based approach. Computational Linguistics, 26 (3): 395-448.2000), developed an algorithm that used cue phrases to generate ‘rhetoric parses’ that provide labels of rhetorical relation to contiguous spans of text. The resulting algorithm parses tree labels blocks of text as belonging to specific rhetorical relations (e.g., justification, evidence, elaboration, and so on), with the connections between blocks specifying which other blocks the given block relates to (e.g., which evidence block the elaboration block relates to). However, these parses simply focus on identifying rhetorical relationships, if any exist, and therefore their use is limited.

### Rhetorical Figure Detection

In rhetorical figure detection, a mathematical model is applied to a text so as to detect the presence of specific rhetorical figures, such as chiasmus, epanaphora, or epiphora (Dubremetz, M. and Nivre, J. (2015). Rhetorical figure detection: The case of chiasmus. In Proceedings of the Fourth Workshop on Computational Linguistics for Literature, pages 23-31; Dubremetz, M. and Nivre, J. (2018). Rhetorical figure detection: chiasmus, epanaphora, epiphora. Frontiers in Digital Humanities, 5:10). However, these methods are simply aiming to identify specific rhetorical figures.

Accordingly, systems and methods that enable additional, alternative, and/or improved means of analyzing content remain desirable.

### SUMMARY

In accordance with one aspect of the present disclosure, a content analysis method is disclosed, comprising: receiving content; computing a rhetoric vector by analyzing a language structure of the content, the rhetoric vector comprising one or more dimensions each representative of a rhetoric aspect of the language structure; and classifying the rhetoric vector with a trained classifier to determine whether a content advisory should be associated with the content.

In some aspects, computing the rhetoric vector comprises computing each dimension, at least partly, using one or more language structure metrics including a distance metric, a proportion metric, and a count metric.

In some aspects, computing the rhetoric vector further comprises computing a word count in the content.

In some aspects, the method further comprises computing a plurality of dimensions of the rhetoric vector.

In some aspects, the method further comprises preprocessing the content, wherein preprocessing the content comprises one or both of: extracting the content from extraneous content, and generating cleaned text from the content.

In some aspects, the content is received in a textual format, and the trained classifier is trained for the textual content.

In some aspects, the content is received in an audio or video format, and the method further comprises converting the format to a textual format and analyzing the language structure of the textual format of the content.

In some aspects, the trained classifier is trained for audio or video content.

In some aspects, the method further comprises generating a content advisory for the content based on one or more dimensions of the rhetoric vector.

In some aspects, the method further comprises associating a content advisory to the content based on one or more dimensions of the rhetoric vector.

In some aspects, the method further comprises outputting the content advisory to a content consumer.

In some aspects, the content advisory is output to the content consumer concurrently with the content or prior to giving access to the content to the content consumer.

In some aspects, the content advisory is output to the content consumer in association with a web search result returning the content.

In some aspects, the method further comprises ranking a webpage containing the content using one or both of the rhetoric vector and a classification of the rhetoric vector by the trained classifier.

In some aspects, the method further comprises adjusting a pay-per-click cost associated with the content based on one or both of the rhetoric vector and a classification of the rhetoric vector by the trained classifier.

In some aspects, the method is performed at a server providing access to the content.

In some aspects, the method is performed at a user device attempting to access to the content.

In accordance with another aspect of the present disclosure, a content analysis system is disclosed, comprising: a processor; and a non-transitory computer-readable memory having computer-executable instructions stored thereon, which when executed by the processor, configure the content analysis system to perform the method of any one of the above aspects.

In some aspects, the system further comprises a database for storing the content in association with the content advisory when generated.

In accordance with another aspect of the present disclosure, a non-transitory computer-readable memory is disclosed having computer-executable instructions stored thereon, which when executed by a processor, configure the processor to perform the method of any one of the above aspects.

### BRIEF DESCRIPTION OF THE DRAWINGS

Further features and advantages of the present disclosure will become apparent from the following detailed description, taken in combination with the appended drawings, in which:

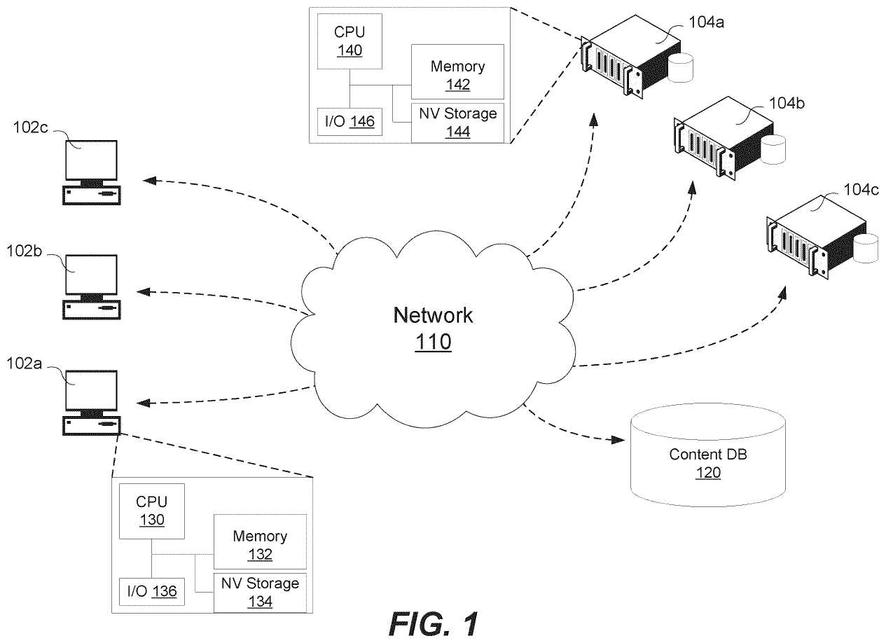

FIG. 1 shows a representation of user devices accessing content over a network, implementing a content analysis method and system;

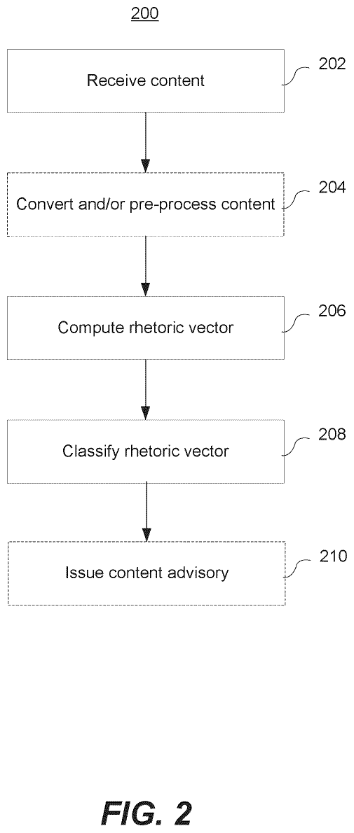

FIG. 2 shows a method for performing content analysis;

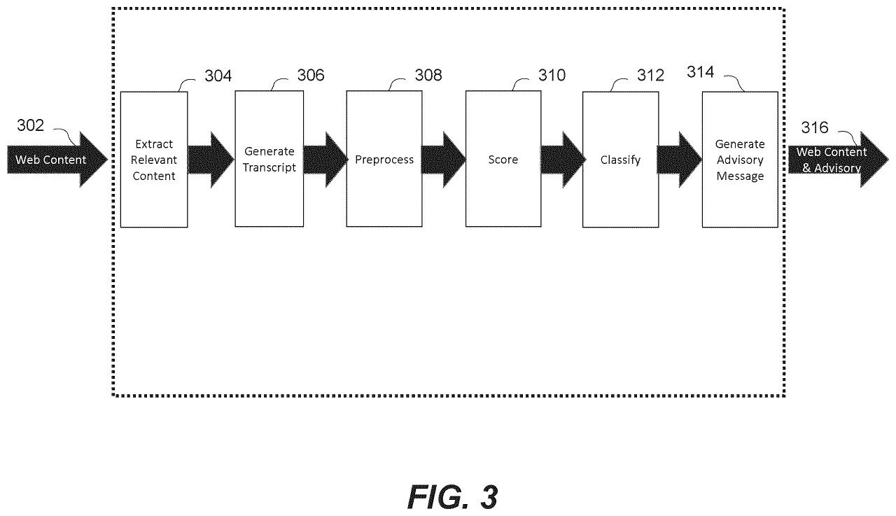

FIG. 3 shows a representation of a flow of the content analysis method;

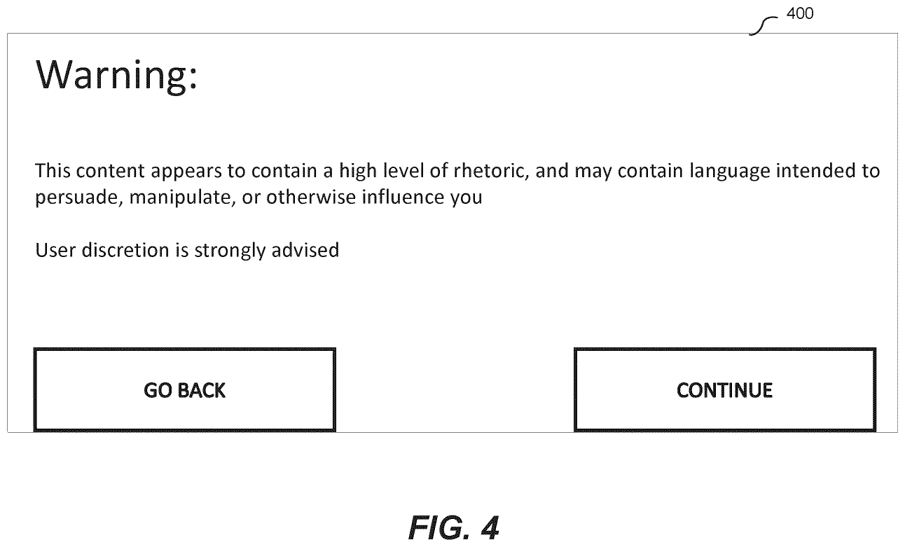

FIG. 4 shows an example of an output that may be generated using the content analysis method; and

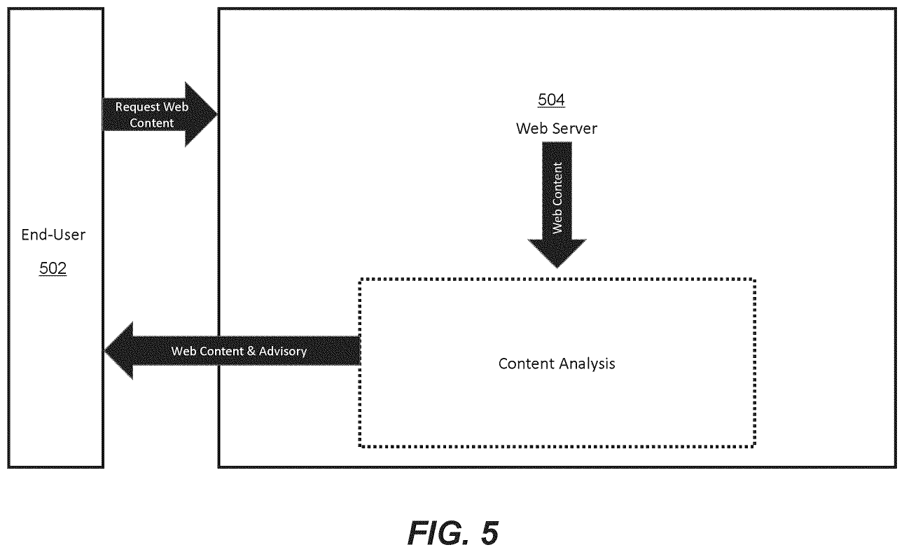

FIGS. 5 to 17 show example implementations for performing content analysis.

It will be noted that throughout the appended drawings, like features are identified by like reference numerals.

### DETAILED DESCRIPTION

In accordance with the present disclosure, systems and methods for content analysis are disclosed that analyze content and compute a rhetoric vector comprising one or more dimensions each representative of a rhetoric aspect of a language structure of the content. The rhetoric vector is classified using a trained classifier to determine whether a content advisory should be associated with the content.

In particular implementations, the content analysis systems and methods disclosed herein provide an automated tool for analyzing content and can be used for generating/issuing content advisories. Content advisories are determined by classifying the rhetoric vector computed for the content, where the rhetoric vector is indicative of a rhetorical force of the content.

In some implementations, the content analysis systems and methods are configured to extract the relevant content from any extraneous content and to generate cleaned text from the content. If required, the content analysis systems and methods may generate a transcript of any audio. Generating a transcript of an audio may be performed when the content is received in an audio or video format.

The content text is preprocessed and fed into a scorer that computes various scalar measures of rhetorical force. These measures of rhetorical force result in a rhetoric vector that gets passed to a trained classifier that determines if an advisory should be paired with the content. This advisory may then be issued to a content consumer, and access to the requested content may be controlled.

The scorer that computes the rhetoric vector indicative of rhetorical force is not required to take the content's semantics into consideration, unlike with hate speech and fake news detection. That is, the content analysis systems and methods are configured to analyze how things are said, not necessarily what is said, thus eliminating biases that are well-known problems in hate speech and fake news detection techniques.

The content analysis systems and methods may not necessarily prevent users from accessing content, and may instead only provides advisories and ask for the content consumer's informed consent to display the requested content. The content analysis systems and methods can be deployed in a wide-variety of ways, including both server-side and client-side deployments, and across a wide-array of tools, products, or services, such as web browsers, search engines, smartphone or computer applications, etc.

Further, the rhetoric vector indicative of rhetorical force produced by the scorer and/or the content advisory determination can also be used to help inform search results, as well as rank or score websites/content creators, or adjust/inform pay-per-click pricing models. Here, the rhetoric vector and/or the content advisory determination can be integrated into existing algorithms for search, content rankings, and/or pay-per-click, such that the rhetoric vectors and/or content advisory determination play a role in determining the outcome of the algorithm (e.g., increasing/decreasing a content's ranking in search results, based-off the advisory determination). Specific integration details may depend specifically on the nature of the algorithm. A simple example of integrating the measures of rhetorical force produced by the scorer into a ranking application would be to have any piece of content that requires an advisory show up below content that does not require an advisory. Likewise, one could increase pay-per-click costs depending on whether the content requires an advisory, or if values in the rhetoric value exceed some threshold.

Unlike existing methods for analyzing content such as hate speech, fake news detection, argument mining, and rhetorical figure detection described above, the systems and methods for content analysis disclosed herein compute a rhetoric vector by analyzing a language structure of the content. That is, the systems and methods for content analysis disclosed herein do not necessarily consider semantics of what is said in the content or attempt to identify specific words or rhetorical figures, but rather evaluate a rhetoric force indicative of an emotive and/or persuasive power inherent to the content by analyzing the language structure of the content. For example, it will be appreciated that not all hate speech is forceful, and that a text can carry a high level of rhetorical force without containing any hate speech. Accordingly, means of detecting hate speech in content require methods which are distinct from the methods disclosed herein. Similarly, there is no overlap between detecting specific rhetorical figures and computing the rhetoric vector in accordance with the present disclosure, which extracts different features of the content and performs a distinct analysis on those features.

The content analysis systems and methods disclosed herein compute a rhetoric vector indicative of a rhetorical force of the content, which is classified to determine whether a content advisory should be associated with the content. Previous approaches to computational rhetoric have either focused on argument mining or detecting specific rhetorical figures, and while these technologies may be interesting and helpful in their own right, rhetorical force is an important dimension when it comes to building a robust advisory system.

Accordingly, one problem the content analysis systems and methods disclosed herein helps to address is the Internet's need for more effective content advisory tools, which can be used to warn users about the potentially harmful effects of the content being consumed. The Internet does not currently have a general purpose advisory system. There are systems capable of warning about hate speech and fake news; however, as previously noted, these systems fail to address root causes of the Internet's content problem.

Embodiments are described below, by way of example only, with reference to FIGS. 1-17.

FIG. 1 shows a representation of user devices accessing content over a network, implementing a content analysis method and system. The systems and methods for content analysis as disclosed herein may be considered as the Internet analog of Broadcast Television's Content Rating System. More specifically, the content analysis system is an automated system that takes in content (be it text, audio, or video) and analyzes the content to determine whether a content advisory should be associated with the content based on a rhetorical force of the content. The content analysis systems and methods disclosed herein can be deployed on either the server-side or the client-side, and can be integrated into a wide range of products and services, including but not limited to, search engines, web pages, content platforms, and computer applications.

In FIG. 1, user devices 102a, 102b, 102c access web content (which may be in text, audio, or video format) provided by web servers 104a, 104b, 104c over a network (i.e. the Internet) 110. The content may be stored in association with the web servers 104a-c or remotely in a content database 120 and retrieved therefrom.

The content analysis systems and methods disclosed herein ingest web content and determine how much rhetorical force is carried by the content, and can be used to decide whether a content advisory is warranted given the content's rhetorical force. As described above and will be described further herein, the content analysis may be performed by the user devices 102a-c or by the web servers 104a-c. For example, user device 102a is shown comprising hardware elements including a CPU 130, non-transitory computer-readable memory 132, non-volatile storage 134, and input/output interface 136. The non-transitory computer-readable memory 132 may have computer-executable instructions stored thereon which when executed by the CPU 130, configure the user device 102a to implement a content analysis method as described herein. Similarly, the web server 104a is shown comprising hardware elements including a CPU 140, non-transitory computer-readable memory 142, non-volatile storage 144, and input/output interface 146. The non-transitory computer-readable memory 142 may have computer-executable instructions stored thereon which when executed by the CPU 140, configure the web server 104a to implement a content analysis method as described herein. It will be appreciated that the content analysis systems and methods can be deployed in a wide-variety of ways, including both server-side and client-side deployments, and across a wide-array of tools, products, or services, such as web browsers, search engines, and smartphone or computer applications, just to name a few. Various ways of implementing the content analysis systems and methods are described in more detail with reference to FIGS. 5 to 17.

Based on the content analysis, a content advisory may be generated and presented to the content consumer (i.e. a user) at the user device attempting to view the content. If an advisory is issued the content analysis system may control access to the content by way of user-prompts. That is, the content analysis system may or may not prohibit access to content, and may only for example (i) provide advisories, and (ii) asks for the user's informed consent to present the requested content, given the information provided by the advisory. If the user does elect to view content, the advisory is meant to serve as a cognitive prime that attempts to inoculate the user against potentially harmful effects of the content. For example, if the user is presented with an advisory warning them that the content they wish to consume contains a high level of rhetoric, the user can approach the content from a defensive position, and read it with a more skeptical eye. Evidence shows that this type of priming can influence an individual's perception and behaviour. For example, a meta-analysis by Meisner (Meisner, B. A. (2012). A meta-analysis of positive and negative age stereotype priming effects on behavior among older adults. Journals of Gerontology Series B: Psychological Sciences and Social Sciences, 67 (1): 13-17.) of 137 studies showed that positive/negative primes elicited positive/negative effects on behaviour, such that positive primes elicited positive behaviours and visa-versa. This relationship has also been demonstrated for opinions, with primes of positive opinions eliciting positive views in participants (Kesebir, P., Pyszczynski, T., Chatard, A., and Hirschberger, G. (2013). Reliving history: Using priming to assess the effects of world events on public opinion. Peace and Conflict: Journal of Peace Psychology, 19 (1): 51.), which coincide with evidence showing that once individuals have been primed about an issue, they tend to think about that issue more seriously (Wang, A. (2007). Priming, framing, and position on corporate social responsibility. Journal of Public Relations Research, 19 (2): 123-145). Moreover, there is also evidence showing the effectiveness of advisories in influencing beliefs and behaviours, be it for cigarettes (Noar, S. M., Hall, M. G., Francis, D. B., Ribisl, K. M., Pepper, J. K., and Brewer, N. T. (2016). Pictorial cigarette pack warnings: a meta-analysis of experimental studies. Tobacco Control, 25 (3): 341-354.), alcohol (Wigg, S. and Stafford, L. D. (2016). Health warnings on alcoholic beverages: perceptions of the health risks and intentions towards alcohol consumption. PLOS One, 11 (4): e0153027.), food and drink (Grummon, A. H., Smith, N. R., Golden, S. D., Frerichs, L., Taillie, L. S., and Brewer, N. T. (2019). Health warnings on sugar-sweetened beverages: simulation of impacts on diet and obesity among us adults. American Journal of Preventive Medicine, 57 (6): 765-774), or television (Bozoklu, C. P. (2018). Do tv content rating systems necessary for protecting adolescents? adolescents' perceptions and parents' attitudes towards smart signs. C a̧nkιrι Karatekin \dot{ } Universitesi \dot{ } Iktisadi ve \dot{ } Idari Bilimler Fakültesi Dergisi, 8 (1): 31-54.). Indeed, there is a longstanding history of effective advisory systems, but no such system is in place for Internet content, much less an automated one.

The content analysis systems and methods can also be integrated in web search technologies. For example, when a search engine indexes a webpage, it can run the content analysis systems on the webpage's content and store the results in a database (e.g., Content Database 120). Then, when search results are displayed to the user, webpages that the content analysis has identified as potentially problematic can (i) be given an advisory label within the search results, or (ii) produce an advisory message when the user clicks on that page's link within the search results. Moreover, the results from the scorer can be stored and used to help improve search results, either by helping to provide more nuanced page ranking or acting as a filter to exclude certain pages from results. The results from the scorer can also be used to adjust pay-per-click rates for advertisers.

FIG. 2 shows a method 200 for performing content analysis. In short, the method 200 provides an automated method for determining whether a content advisory should be associated with content by determining a rhetorical force of the content. As described with reference to FIG. 1, the method 200 may be performed by a user device or web server such as a content provider, search engine, or other platform.

Method 200 comprises receiving content (202). As described with reference to FIG. 1, the content to be analyzed may be received in a textual, audio, or video format.

In cases where the content is already stored on the memory of the device implementing method 200, receiving the content may comprise retrieving the content for analysis.

Method 200 further comprises computing a rhetoric vector by analyzing a language structure of the content (206). The rhetoric vector comprises one or more dimensions each representative of a rhetoric aspect of the language structure

The rhetoric vector is computed by computing and scoring one or more dimensions each representative of a rhetoric aspect of the language structure of the textual content. In some aspects, computing the rhetoric vector comprises computing each dimension, at least partly, using one or more language structure metrics including a distance metric, a proportion metric, and a count metric. In some aspects, computing the rhetoric vector further comprises computing a word count in the content.

The rhetoric vector is classified with a trained classifier (208) to determine whether a content advisory should be associated with the content.

Different classifiers may be trained for different formats of content and for different languages of the content being analyzed. That is, different classifiers may be trained for when the content is received as textual content compared to when the content is received as audio or video content and converted. Different types of classifiers may be used, such as Naïve Bayes, Logistic Regression, Boosted Decision Tree, or Random Forest. The classifiers may be binary in nature (i.e. indicative of whether or not a content advisory should be associated with the content), or multi-tiered (e.g. indicative of whether or not a content advisory should be associated with the content or whether it is uncertain if a content advisory should be associated with the content).

Optionally, a content advisory may be issued in association with the content (210) based on the classification of the rhetoric vector.

When an advisory is issued to the user, it can be generic or it can contain more nuanced information derived from the scorer or other intelligent systems. For example, if the content scores high across the repetition and iteration dimensions, the advisory can contain language to this effect. The content advisory may therefore be generated for the content based on one or more dimensions of the rhetoric vector. Alternatively, one or more generic content advisories may exist, which may be associated to the content based on one or more dimensions of the rhetoric vector.

Thus, if the classifier determines that an advisory should be paired with the content, an advisory can be generated or associated to the content. In some implementations, the content advisory may be generated or associated to the content based on values of one or more dimensions of the rhetoric vector. In other implementations, once the classifier determines that an advisory should be paired with the content, an advisory may be generated or associated to the content without taking into account the values of the one or more dimensions.

In some implementations, the content advisory may not prevent users from accessing content, and may instead only provide an advisory and asks for the user's informed consent to display the requested content. The content advisory may be output to the content consumer concurrently with the content or prior to giving access to the content to the content consumer. Alternatively, the content advisory may be output to the content consumer in association with a web search result returning the content.

Optionally, method 200 may comprise converting and/or pre-processing the content (204) prior to computing the rhetoric vector (206). To compute the rhetoric vector, the language structure is analyzed from textual content, which may be the original format of the content or may be generated from an audio/video format of the content by converting the audio/video format to textual format (e.g. generating a text transcript). For example, if the relevant content is in audio/video format, it is converted into a text transcript. Pre-processing the content may include extracting relevant content from spurious content, for example by removing extraneous content such HTML/CSS, Javascript, ad content, menus, and other extraneous text. Pre-processing the content may also involve performing one or more of the following to produce cleaned data/text: remove emojis; remove numeric characters; remove newline characters; expand contractions and fix slang (e.g., “can't” becomes “can not”; “lol” becomes “laugh out loud”; convert all text to lowercase; generate sentence tokens; remove punctuation; remove excess whitespace; generate Parts-of-Speech tags (POS tags); lemmatize words and generate their antonyms; and construct n-grams of various lengths.

The method 200 may also comprise ranking a webpage containing the content using one or both of the rhetoric vector and a classification of the rhetoric vector by the trained classifier.

The method 200 may further comprise adjusting a pay-per-click cost of a webpage containing the content based on one or both of the rhetoric vector and a classification of the rhetoric vector by the trained classifier.

When computing the rhetoric vector that comprises one or more dimensions each representative of a rhetoric aspect of the language structure, the language structure may be analyzed using one or more language structure metrics such as a distance metric, a proportion metric, and a count metric.

Natural languages are a set of symbols, and rules for combining these symbols. For example, letters are combined into words, words are combined into sentences, and so on. Analyzing the language structure involves looking at how symbols are combined so as to make judgements of rhetoric aspects in the content, which works because rhetoric aspects elicit specific patterns of symbols. That is, symbols are repeated, specific symbols are used in close proximity to each other, etc. Rhetorical force may be considered as the emotive/persuasive power elicited by these patterns providing the rhetoric aspects in the content. Accordingly, to compute the rhetoric vector the use of natural language to provide patterns indicative of rhetoric aspects is evaluated. In other words, the use and combination of symbols (i.e. words) is evaluated, and not necessarily what respective symbols/words mean.

The distance metric may be considered as the number of words or POS tags between two similar words or POS tags or two similar set of words or POS tags (n-grams). The distance metric allows to better appreciate the emphasis that is put on a word or POS tag or set of words or POS tags. That is, the shorter the number of words or POS tags between two similar words or POS tags is, the more likely these similar words or POS tags are to carry higher rhetoric force.

The proportion metric may be considered as a ratio between a number of times a word or POS or n-gram is repeated in a content and a length (e.g., word count, sentence count, etc.) of the content or a segment of content. A word or POS or n-gram that is repeated three times in a text of fifteen words is more likely to have more rhetoric force than a word or POS or n-gram repeated three times in a text of a thousand words.

The count metric may be seen as the number of times a specific word or POS or set of words or POSs is repeated throughout the content or a segment of content, or a tally of the number items belonging to a specific class of items (e.g., number of sentences, number of words, etc.).

As described in more detail below, various dimensions of the rhetoric vector may be computed by computing each dimension, at least partly, using one or more language structure metrics including a distance metric, a proportion metric, and a count metric.

Dimensions of the rhetoric vector representative of rhetoric aspects of the language structure may include one or more of the following:
a) Local repetition and iteration (local RI);
b) Combined repetition and iteration (combined RI);
c) Combined comparisons and contrasts (combined CC);
d) Combined antonym usage (combined ANT);
e) Eight combined Part-of-Speech (POS) dimensions (one for each of verb, noun, pronoun, adjective, adverb, adposition, coordinating conjunction, and determiner); and
f) Word-level entropy of the cleaned text.

Additional dimensions of the rhetoric vector may be computed as well, including:

g) Word count of the cleaned text.

That is, computing the rhetoric vector may further comprise computing a word count in the content. The word count allows to put the computed dimensions a) to f) indicative of a rhetoric aspect of the language structure into context. That is to say, scores computed for a content having text with one sentence of 15 words can be treated differently from content having text with 500 words.

Accordingly, a rhetoric vector of one or more dimensions, in some instances a plurality of dimensions, such as up to 14 dimensions described above, may be computed at (206) in method 200, as described further below.

As described herein, “local” will refer to rhetoric independent of sentence, distant will refer to rhetoric dependant on sentence, and “combined” will refer to the combination of local and distant rhetoric. For example, consider the following texts:
(1) I will warrant him as gentle as a lamb. I will warrant his as gentle as can be.
(2) I will warrant him as gentle as a lamb; I will warrant him as gentle as can be.

Here, the two texts differ only in terms of their respective punctuation. Local rhetoric ignores that the first text has two sentences and the second only has one, but distant rhetoric does not. Thus, these two texts will have the same local rhetoric dimensions, but differ in their distant and combined rhetoric dimensions.

As also described herein, the following nomenclature is used:
(1) Current word/sentence/POS refers to the word, sentence, or POS rag the scorer is currently focusing on;
(2) Forward text refers to all of the text that comes after the current word/sentence/POS;
(3) Forward of [location] refers to all of the text that comes after the specified location within the text;
(4) Nearest instance refers to the first instance of an element within the forward text. For example, if the current word is “cat” then the nearest instance of the current word would be the first “cat” in the forward text;
(5) Step refers to moving one item down the cleaned text/sentence, where “item” can be a word, sentence, or POS tag;
(6) N-gram refers to a contiguous sequence of n items from a given sample of text. For example, if the text is given by “I love Lucy”, then the text has three 1-grams in:
(a)
(b) love
(c) Lucy,
two 2-grams in:
(a) I love
(b) love Lucy,
and one 3-gram in:
(a) I love Lucy;
(7) Longest matching n-gram refers to the longest n-gram for X that is also an n-gram for Y. For example, if X is given by “I love Lucy” and Y is given by “I love Sally”, then the longest matching n-gram between X and Y is “I love”.

Examples of computing dimensions of the rhetoric vector are described below. The dimensions are computed using a scorer built into method 200 for performing content analysis. Dimensions a) through f) are representative of a rhetoric aspect of the language structure. Each dimension encodes how much rhetorical force or weight the text carries across that dimension. It will be appreciated that the examples below are non-limiting and that different equations for computing scores could be used to compute scores of the various dimensions without departing from the scope of the present disclosure.

### a) Local RI

To compute a local repetition measure, the scorer fixates on a word, ω, then scans the forward text to find the first instance of that word, η. It then compares the n-grams for η against the n-grams for ω to find the longest match, [symbol] . The number of word steps to η, denoted [symbol] , is then extracted and a score [symbol] computed via:

$${ℱ}_{𝓇ℓ} = 1 - {e}^{- \vert ℳ \vert / \sqrt{{𝒮}_{𝓌}}}$$

where | [symbol] | is the number of words that comprise [symbol] . If there is no η, then the scorer takes one word step down the text and fixates on the new word; otherwise, it takes | [symbol] | word steps down the text (i.e., it skips over the rest of the longest matching n-gram). When the scorer takes two or more steps down the text, the generated [symbol] value represents the score for the entire phrase/n-gram; otherwise, the value represents the score for the single word it is fixating on. Once the entire text has been scanned, the average is taken, making the overall equation for the local repetition dimension:

$$\overline{{ℱ}_{𝓇ℓ}} = \frac{1}{\vert Ω \vert} {\sum }_{ω ∈ Ω} {ℱ}_{𝓇ℓ}^{ω}$$

where Ω is the multiset of all words/phrases that elicit non-zero [symbol] score.

Conceptually, a repeating n-gram is viewed as having a certain amount of intrinsic force (i.e., for all | [symbol] | the [symbol] value at [symbol] =1 is 1). However, this force is going to “leak out” over time; the greater the distance between the repetitions, the more the force leaks out. This said, the rate at which this force leaks will also vary as a function of | [symbol] |. Longer n-grams will leak slower than shorter n-grams, which makes sense given the prevalence of stopwords and other short phrases. Moreover, the prevalence of stopwords means they tend to dominate the average. But as the number of more complex repetitions increases, not only will this increased complexity drive up the average by itself, there is a compounding effect as stopwords become embedded within these more complex repetitions, reducing the number of stopwords left to dominate the average due to the scorer taking | [symbol] | steps down the text.

### b) Combined RI

In contrast to local repetition, combined repetition takes periods (sentences) into consideration. Once again, the scorer fixates on a word, ω, but instead of scanning all of the text forward of that word, it scans all of the sentences forward of the current sentence. When scanning, it finds the nearest instance of that word, η, but instead of counting word steps, it counts sentence steps, or [symbol] . The scorer then compares the n-grams for η against the n-grams for w to find the longest match, [symbol] ; however, this match is limited to the current sentence. For example, if the 7-gram for ω marks the end of the sentence ω is in, the scorer will not consider Aug. 9, 2010-grams as they carry over into the next sentence. Once the longest match is identified, the scorer then scans the entire text for [symbol] to determine the proportion of sentences it appears in, or [symbol] . After all these parameters have been extracted, the score [symbol] is computed via:

$${ℱ}_{rd} = \frac{\vert M \vert \sqrt{{𝒫}_{r}}}{ln ( {S}_{s} ) + \vert M \vert}$$

If there is no η, then the scorer takes one word step down the text and fixates on the new word; otherwise, it takes | [symbol] | word steps down the text. Once the entire text has been scanned, the average is taken, making the overall equation for the distant repetition dimension:

$$\overline{{ℱ}_{rd}} = \frac{1}{\vert Ω \vert} {\sum }_{ω ∈ Ω} {F}_{rd}^{ω}$$

where Ω is the multiset of all words/phrases that elicit a non-zero [symbol] score.

Conceptually, rhetorical force is considered as leaking out as a function of | [symbol] | and [symbol] , only here an additional [symbol] term is added that determines how much rhetorical force is intrinsic to the word/phrase (i.e., [symbol] sets the [symbol] value when [symbol] =1).

### c) Combined CC

To process comparisons and contrasts (C&C), a dictionary of C&C words is used. The C&C words may include for example: ‘contrast’, ‘however’, ‘but’, ‘except’, ‘though’, ‘although’, ‘conversely’, ‘neither’, ‘between’, ‘despite’, ‘than’, ‘whereas’, ‘unlike’, ‘alternatively’, ‘meanwhile’, ‘before’, ‘after’, ‘both’, ‘or’, ‘nor’, ‘not’, ‘while’, ‘instead’, ‘notwithstanding’, ‘nevertheless’, ‘like’, ‘comparatively’, ‘too’, ‘besides’, ‘differ’, ‘furthermore’, ‘further’, ‘instead’, ‘nevertheless’, ‘otherwise’, ‘regardless’, ‘unless’, ‘unlike’, ‘while’, ‘yet’, etc.

The scorer first determines the proportion of sentences that contain at least one word from the dictionary of C&C words referred to herein as [symbol] . The scorer then scans over the text. When the scorer fixates on a C&C word, it then scans the forward text for the next C&C word. The number of word steps, S [symbol] , to the next C&C word is extracted and a score, [symbol] , computed via:

$${F}_{cc} = \frac{\sqrt{{P}_{cc}}}{ln ( {S}_{w} ) + 1}$$

making the overall equation for combined C&C:

$$\overline{{F}_{cc}} = \frac{1}{\vert Ω \vert} {\sum }_{ω ∈ Ω} {F}_{cc}^{ω}$$

where Ω is the multiset of all words in the text that elicit a non-zero [symbol] score. Conceptually, combined C&C is the same as combined repetition, only the scorer concerns itself with [symbol] instead of [symbol] , and word steps instead of sentence steps. Moreover, because the length of each item in the C&C dictionary is 1, | [symbol] | is replaced with 1.

### d) Combined ANT

To compute combined antonyms, a set containing all of the antonyms to words in the text is used. Here, the set of antonyms for a word ω is denoted by α_{ω}, which makes the set of all antonyms [symbol] :

$$A = {⋃}_{ω ∈ T} {α}_{ω}$$

where [symbol] is all of the words in the cleaned text. With this set in hand, the scorer scans the text to determine the proportion of sentences that contain a word in [symbol] , denoted [symbol] . The scorer then scans and fixates, looking forward to find the nearest instance of a word in α_{ω}. The number of word steps, [symbol] , to α_{ω} is then extracted, and [symbol] computed via:

$${F}_{a} = \frac{\sqrt{{P}_{a}}}{ln ( {S}_{w} ) + 1}$$

making the overall equation for combined antonyms:

$$\overline{{F}_{a}} = \frac{1}{\vert Ω \vert} {\sum }_{ω ∈ Ω} {F}_{a}^{ω}$$

where Ω is the multiset of all words that elicit a non-zero [symbol] score.

### e) Combined POS

(NOTE: The following is applied to each of the eight POS tags)

For the relevant POS tag, ρ, the scorer determines what proportion of sentences, [symbol] , contain ρ. The scorer then scans and fixates, looking ahead for the next instance of ρ. It then takes the number of word steps to the next instance, [symbol] , and computes [symbol] via:

$${F}_{p} = \frac{\sqrt{{P}_{p}}}{ln ( {S}_{w} ) + 1}$$

making the overall equation for the relevant POS tag:

$$\overline{{F}_{p}} = \frac{1}{\vert Ω \vert} {\sum }_{ω ∈ Ω} {F}_{p}^{ω}$$

where Ω is the multiset of all words that elicit a non-zero [symbol] score.

To further demonstrate the computation of a rhetoric vector for text, the following text is used as an example:

“I love Lucy. I love Betty. I love Mary.”

The computation of the rhetoric vector for the example text may comprise computing the following dimensions:

### a) Local RI:

Here, the scorer would begin by fixating on the first word, “I”. It would then scan all of the text forward of this word to find its nearest instance, which in this case is the “I” in “I love Betty”. The scorer would then find the longest matching n-gram between the two instances of “I”, which in this case is the 2-gram “I love”. It would then extract the relevant information: how many word steps from the first 2-gram to the second 2-gram (in this case, 2 steps; i.e., it steps from “love” to “Lucy”, then from “Lucy” to “I”), and the length of the longest matching n-gram, which is 2. These parameters would then be applied to:

$${F}_{rd} = \frac{\vert M \vert \sqrt{{P}_{r}}}{ln ( {S}_{s} ) + \vert M \vert}$$

as previously discussed, resulting in a force score for the first instance of “I love”. The scorer would then take two steps down the text (because the longest matching n-grams has a length of 2; i.e., it would step from “I” to “love”, then from “love” to “Lucy”) and fixate on the new word. The scorer would then scan down the forward text for the nearest instance of “Lucy”, only in this example there is only the one instance. As a result, the word “Lucy” is ignored as it is deemed to carry no force, and the scorer takes one step down the text to “I” and fixates on it. The scorer then scans down the forward text for the nearest instance of “I”, which in this case is the “I” in “I love Mary.” It then extracts the relevant information again—an n-gram length of 2 that is 2 steps away—and again applies these parameters to the equation above. The scorer then takes two steps down the text and fixates on the word “Betty”. It then scans the forward text, and because this is the only instance of “Betty”, it is discarded just as “Lucy” was. The scorer then takes one step down the text and fixates on the final “I”, but is has no forward instance so it is discarded. It then takes another step down the text and fixates on “love”, but this is, again, discarded. So the scorer takes one more step to fixate on “Mary”, but it too is discarded. At this point, the scorer has reached the end of the text, so it computes the average force score for all words/phrases that carry rhetorical force across the RI Local dimension (i.e., the first two instances of “I love”).

### b) Combined RI:

Here, the scorer would again start by fixating on the first word, “I”. It then scans the forward sentences to find the next instance of “I”, which in this case would be the “I” in “I love Betty”. The scorer then find the longest matching n-gram between the two instances, which in this case is “I love”. It then records how many sentence steps to this next instance (in this case 1 as the scorer has to step forward 1 sentence), then scan the remaining sentences in the text and counts how many sentence, in total, contain the longest matching n-gram, which in this case is three. To get the proportion of sentences the longest matching n-gram appears in, we divide the appearance count by the total sentence count, which in this case is 3/3. This proportion, alongside the length of the longest matching n-gram (which is 2 in this case) and the number of sentence steps (1 in this case) are then applied to the following equation:

$${F}_{rd} = \frac{\vert M \vert \sqrt{{P}_{r}}}{ln ( {S}_{s} ) + \vert M \vert}$$

to generate a force score. The scorer then takes two word-steps down the text (because the longest matching n-gram is 2), and fixates on the new word, in this case “Lucy”. It then scans down all the forward sentences for the next instance of “Lucy”, but because there is no other instance, it is discarded. The scorer then takes one word step down the text and fixates on the second “I”. It then scans the forward sentences for the nearest instance of “I”, which in this case is the “I” in “I love Mary”. The scorer once again finds the longest matching n-gram between the two instances (“I love”), then computes both the number of sentence steps to the nearest instance, and the proportion of sentences that contain the n-gram. All of the parameters (sentence steps, length of longest matching n-gram, and proportion of sentences containing the longest matching n-gram) are then passed to the equation above to compute a force score. The scorer then takes two word-steps down the text and fixates on “Betty”. The forward scanning process is again repeated, and the word again discarded because there is no instance of “Betty” in the forward text. The scorer then takes one word-step down the text to fixate on the third “I”, repeating the scanning and rejection process. It then takes one word-step down the text and fixates on “love”, again repeating the scanning and rejection process. Finally, it takes one last word-step to fixate on “Mary”, which is also discarded. At this point, the scorer has reached the end of the text, so it computes the average force score for all words/phrases that carry rhetorical force across the RI Combined dimension (i.e., the first two instances of “I love”).

### c) Combined CC:

First, the scorer computes the proportion of sentences that contain at least 1 C&C word. Once this proportion has been computed, it begins scanning and fixating. Here, the scorer begins with the first word in the text, and checks to see if it is a C&C word. If it is a C&C word, then the scorer scans the forward text to find the nearest instance of another C&C word (note: it does not have to be the same C&C word as what is being fixated on). If a nearest instance is found, the scorer counts the word steps to this nearest instance, then applies this value and the computed proportion to:

$${F}_{cc} = \frac{\sqrt{{P}_{cc}}}{ln ( {S}_{w} ) + 1}$$

so as to generate a force score. If no nearest instance is found, the scorer discards the word and takes one word-step down the text. If the current word is not a C&C word, the scorer takes one word-step down the text. In the case of the example sentence above, there are no C&C words, so the scorer will simply fixate on the first word, then take one step, then fixate again, then step again, and so on until it reaches the end of the text. In this case, the average force score for the Combined CC dimension would be 0. In a preferred embodiment, if there is one or more word that carry rhetorical force across the dimension, then the average is taken.

### d) Combined ANT:

First, the scorer computes the proportion of sentences that contain one or more antonyms from the set of all antonyms for the text. Next, the scorer fixates on the first word in the text, then scans the forward text for any of the current word's antonyms. If the current word has no antonyms, or the forward text does not contain any antonyms, the scorer takes one word-step down the text. If the forward text does contain an antonym, then it takes the number of word steps to the nearest instance (i.e., the first occurring antonym in the forward text). This step value and the previously computed proportion are then applied to:

$${F}_{a} = \frac{\sqrt{{P}_{a}}}{ln ( {S}_{w} ) + 1}$$

to generate a force score. The scorer then takes one word-step down the text and repeats this process until the entire text is scanned. With respect to the sample sentence above, none of the words in the text have an antonym that is also in the text, so the average force score for the dimension is 0. In a preferred embodiment, if there is one or more words that carry force across the dimension, then the average is taken.

### e) Combined POS:

For the example sentence, the sequence of POS tags is: NOUN VERB NOUN. NOUN VERB NOUN. NOUN VERB NOUN. Moreover, the following is applied to each of the 8 relevant POS tags:

First, the scorer computes the proportion of sentences that contain the relevant POS tag. Then it begin scanning and fixating, only instead of scanning words, it scans the POS tag sequence. It fixates on the first tag in the sequence and checks to see if it is the relevant POS tag. If it is, it scans the forward sequence for the nearest instance. If there is no nearest instance, or if the tag it is fixating on is not the relevant tag, the scorer discards the tag and takes one tag-step down the sequence. If there is a nearest instance, the scorer computes the number of tag-steps to the nearest instance, and applies this value and the proportion value to:

$${F}_{p} = \frac{\sqrt{{P}_{p}}}{ln ( {S}_{w} ) + 1}$$

so as to compute a force score. The scorer then takes one step down the sequence and repeats the process. In a preferred embodiment, once the entire sequence has been scanned, the average is computed for the relevant POS tag. In a preferred embodiment, if no tags are found to carry rhetorical force, then the average for the relevant POS tag dimension is 0.

### f) Word-Level Entropy:

To compute word-level entropy, a standard entropy calculation may be used with a log of base 2:

$$H ( X ) = - {\sum }_{x ∈ X} p ( x ) {log}_{2} ( p ( x ) )$$

where X is the set of all unique words in the content. In the example sentence above, X={I, love, Lucy, Betty, Mary}, with p(I)=⅓, p(love)=⅓, p(Lucy)= 1/9, p(Betty)= 1/9, and p(Mary)= 1/9.

### g) Word Count:

The word count for the content is gathered during the preprocessing stage, and is simply a count of all the words in the content. In the example given above, the word count is 9.

In some instances, the word count can be seen as a dimension of the rhetoric vector that the classifier uses to help draw a decision boundary between classes (“warn” or “no warn”) in the N-dimensional space defined by the rhetoric vector. For example, most dimensions of the rhetoric vector are averages (e.g., the average amount of RI Local force in the content). The word count dimension helps place those averages into a broader context, making it easier for the classifier to issue advisories. For instance an RI Local score of 0.75 in a text with 1 sentence (say 15 words) is different from a similar RI local score in a text with 500 words. Technically, the RI local force score (for example) of a longer text could be isolated to single sentence in that text, but that would be exceedingly rare, and it is almost always the case that force scores are born from a multitude of sentences or chunks of text.

It is noted that the set of dimensions used for computing the rhetoric vector described herein is not exhaustive and that other dimensions may be computed. Moreover, the dimensions described herein may be modified appropriately without departing from the teachings of the instant disclosure.

For example, although the example discussed above is in English, it will be appreciated by a person skilled in the art that the method can be applied to other languages as well and that different dimensions of the rhetoric vector and their computations can be updated accordingly based on a language structure of different languages being analyzed.

The rhetoric vector may be represented by an array of float numbers except for one integer representing the word count dimension.

The classifier may operate on a full rhetoric vector produced by the scorer, or only a subset of dimensions that have been computed. In cases where the classifier operates on only a subset of dimensions that have been computed by the scorer, the scorer may be adapted to compute only dimensions relevant for the classifier. Thus, depending on the application, an appropriately chosen subset of the metrics may be used to compute the rhetoric vector.

To train the classifiers, a representative sample of Internet content may be gathered and labelled using human raters that consume the content and provide training labels regarding what type of advisory each content should have. By eschewing semantics, the size of the problem space is significantly reduced. That is, instead of being defined by all the X's a person can say, the space is defined by all the ways a person can say these X's. Here, for every X a person can say there are a finite set of ways they can say it (W). Moreover, due to the constraints imposed by the rules of English, for example, there is a lot of overlap in the ways a person can say these X's (i.e., |∩Wₓ| is relatively large), and the number different ways a person can say these X's is much smaller than all the X's a person could theoretically say (i.e., |∪Wₓ|<|∪Xᵢ|). Or in other words, the rules of English provide a relatively small number of templates for how any X can be said, and there are fewer templates than X's that can be inserted into these templates, making the problem space much smaller than if semantics were taken into consideration as only the templates need to be taken into account, not what goes into said templates. An assumption was used that collecting data across a wide-range of topics and topic positions would inherently capture a large subset of U Wₓ. While English has been used as an example, the method 200 may be applied to other languages and modified as appropriate.

Overall, three core datasets were collected: one containing long-form text content (100 or more words) such as blogs, reviews, news articles, social media posts, transcripts of political speeches, etc.; one containing YouTube™ videos, excluding music and fiction; and one containing short-form text (99 or fewer words). Transcripts of political speeches were used in the long-form text dataset because these speeches are fundamentally different from normal video content, which tend to use more colloquial language. By contrast, political speeches are almost always written by speechwriters beforehand, and thus are more akin to written text vis-à-vis their adherence to formal grammar, structure, etc. For each dataset, semantics were checked to assess problem space coverage and removed any duplicate entries. For each dataset, 101 train-test splits (70:30) were generated. The training set of the first split was used for cross-validation, and the remaining 100 splits used to confirm that our cross-validation results held across different train-test partitions of the data.

In terms of data collection, all of the samples in the datasets were hand-collected and hand-rated, with approximately 80% collected and rated by two experts who were kept blind to how the scorer worked. All of the samples were rated as either 0=no/low rhetoric, 1=medium rhetoric, and 2=high rhetoric. The remaining data was collected by the scorer's developer; however, they only collected data at the extreme ends of rhetoric (i.e., samples that were easily identifiable as 0 or 2). To construct the various levels for classification, the medium and high rhetoric ratings were collapsed to create a more aggressive classifier; and collapsed the no/low and medium ratings were collapsed to construct a more conservative classifier. As such, users of the content analysis system are able to pre-select how aggressive they want their advisory system to be (e.g., have little tolerance for rhetoric and issue advisories liberally, or have a higher tolerance for rhetoric and issue advisories conservatively).

In some instances, users of the content analysis system may be able to select which classification model they wish to use (logistic regression, random forest, naïve bayes, boosted decision tree), and select how many dimensions of the rhetoric vector they wish to use (e.g., full scores, which contain all 14 dimensions; or base scores, which may remove the 8 POS dimensions). This means that for each of the three datasets, a classifier was trained for every model-level-scorer combination (4×2×2=16 classifiers for each dataset; 3×16=48 total classifiers for the content analysis system). The final version of each classifier was trained on the entire dataset (e.g., all 16 classifiers for audio/video were trained on the entire audio/video dataset). Regardless of the combination, all dimensions from the scorer for that combination are fed into the model (either 6 or 14 dimensions, depending on whether the user wants to use base or full scores), and the model will use these dimensions to return a binary classification of 0=no, this does not require an advisory; or 1=yes, this does require an advisory. How the model makes this determination depends on the specific model-level-scorer combination, but in all cases, the learning algorithm used by the model is well-established and open-source.

In some instances, non-binary classifiers may be used to generate classifications across more than 2 classes. Examples of classes may include: yes, content advisory needed; no, content advisory not needed; and a content advisory may be required.

It will be appreciated that different content formats may have different classifiers. For example, a classifier used for content that is originally in a text format may be different than a classifier used for content that is originally in an audio or video format and converted to text, because spoken language is different than written language. Accordingly, when the original content is in a textual format, the trained classifier used for classification is trained for the textual content; and when the original content is in an audio or video format, the trained classifier used for classification is trained for audio or video content.

Overall, the trained models produced up to 85% accuracy on the datasets, though more complex models (Boosted Tree and Random Forest) have slightly higher variance than simpler models (Naïve Bayes and Logistic Regression).

As set forth above, the content analysis method 200 differs from existing approaches in a number of ways. For example, the content analysis method 200 does not attempt to identify specific semantics or words (e.g. as in hate speech or fake news detection) or specific rhetorical figures, but takes a more holistic approach to rhetoric by analyzing a language structure of the content for rhetorical aspects that are indicators of rhetorical force. This is important as it means the content analysis method is able to eliminate nearly all biases, which is well-known problem in the hate speech and fake news detection literature (e.g., Koenecke, A., Nam, A., Lake, E., Nudell, J., Quartey, M., Mengesha, Z., Toups, C., Rickford, J. R., Jurafsky, D., and Goel, S. (2020). Racial disparities in automated speech recognition. Proceedings of the National Academy of Sciences, 117 (14): 7684-7689.; Sap, M., Card, D., Gabriel, S., Choi, Y., and Smith, N. A. (2019). The risk of racial bias in hate speech detection. In Proceedings of the 57th Annual Meeting of the Association for Computational Linguistics, pages 1668-1678.). Further, the content analysis method 200 extracts rhetorical aspects to compute the rhetoric vector that are different syntactic and structural indicators than those used in existing techniques, and apply a different mathematical model to those indicators. Additionally, the content analysis method 200 does not require using neural networks. Instead the content analysis method 200 relies on a unique, multi-stage process to determine if a piece of content requires an advisory based on the rhetoric vector.

Of course, semantics-based dimensions and/or use of neural networks could be incorporated into the content analysis method. For example, in some implementations a neural network may be used for classifying the content. Further, in some implementations, the rhetoric vector may be modified to comprise one or more semantic-based dimensions in addition to the non-semantic dimensions described above. In one embodiment, computations of the dimensions of the rhetoric vector may be updated to take into account semantic features such as synonyms. For instance, the distance metric may be modified to measure a distance between synonyms of a word instead of words having the same spelling.

Another instance where use of semantics may be useful is detection of homographs (i.e., words that are spelled the same way but have different meanings and may be sometimes pronounced differently), homonyms, etc. In this case, the emphasis would be on the meaning of a word instead of its spelling or pronunciation.

It is to be noted that in the preferred implementation (i.e., implementation without semantics), the problem of homographs, homonyms, etc. is at least partially solved during preprocessing by lemmatizing the text (i.e., words are converted to their lemma).

FIG. 3 shows a representation of a flow of the content analysis method. As has been described with reference to the method 200, web content 302 is received and the relevant content may be extracted (304). If required, a transcript of any audio or video may be generated (306). The content's text is preprocessed (308) and a rhetoric vector is computed using a scorer (310). The rhetoric vector is passed to a custom-trained classifier that classifies the rhetoric vector (312). Optionally, the content may be associated with a content advisory based on the classification of the content (314). This advisory may then be output to the content consumer (316) concurrently with the content or prior to giving access to the content to the content consumer.

FIG. 4 shows an example of an output 400 that may be generated using the content analysis method. As described above, the content advisory may be generic or it can contain more nuanced information derived from the scorer or other intelligent systems. That is, in some implementations, the content advisory may be generated for the content based on computed values of one or more dimensions of the rhetoric vector. In other implementations, the content advisory may be associated to the content based on computed values of one or more dimensions of the rhetoric vector.

For example, the GO BACK and CONTINUE buttons are provided for the sake of example only, and their usage may be at the discretion of the deployer of the content analysis system.

FIGS. 5 to 17 show example implementations for performing content analysis. If the content analysis systems and methods are deployed as a server-side technology (FIGS. 5 through 13), there are a variety of ways it can be deployed. In general, the server that receives requests from an end-user for content associated with an advisory can respond to this request in one of two ways. One way of responding to a request for content is for the content to be sent with the advisory, in which case the advisory is embedded into the requested content. This embedding can come in two forms: (i) the content advisory is output to the content user concurrently with the content (i.e., the advisory and requested content are shown on the user's screen at the same time), or (ii) the content advisory is output to the content consumer prior to giving access to the content to the content consumer (i.e., the advisory is shown on the user screen first, and if the user selects the next/approve/etc. button, user-side technologies can remove the advisory and show the requested content on the users screen); however if the user selects the back/disapprove/etc. button instead, user-side technologies can return the user to their previous screen, or otherwise prevent the user from seeing the requested content. A second way of responding to a request for content is for the content to not be sent with the advisory, in which case client-side technologies display the advisory message. If the user selects the back/disapprove/etc. button, then a second message can be sent to the server, notifying it of the user's approval. At this point, the server can return the requested content to the user, where client-side technologies can display it.

In the implementation shown in FIG. 5, the end-user 502 makes a request to the web server 504 for content. The web server 504 gathers this content from its own files, then runs a content analysis method as disclosed herein and issues web content and advisories to the end-user 502 via one of the two methods described above. That is to say, method 200 is performed at a server providing access to the content.

In some implementations, method 200 may be implemented directly at a user device attempting to access to the content.

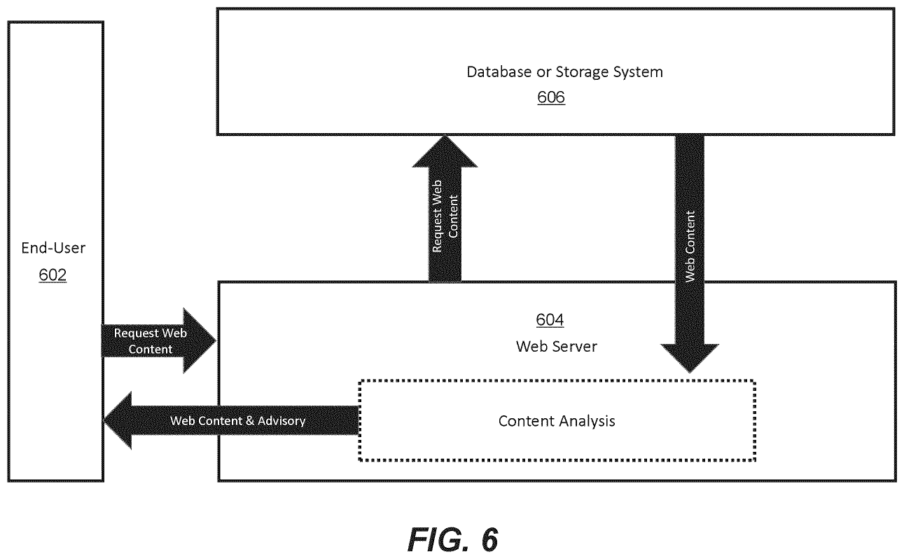

In the implementation shown in FIG. 6, the end-user 602 makes a request to the web server 604 for content. The web server 604 gathers this content from a database or storage system 606, then runs the content analysis method as disclosed herein and issues web content and advisories to the end-user 602 via one of the two methods described above.

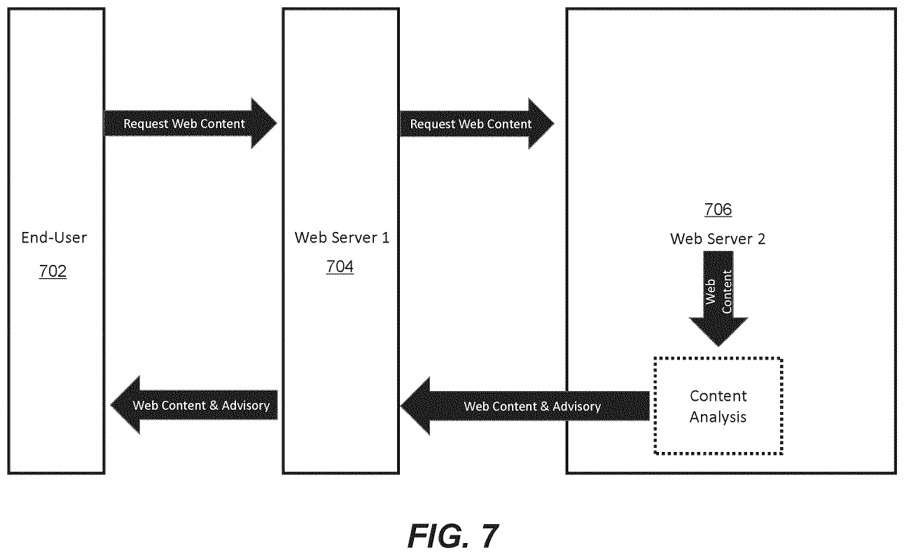

In the implementation shown in FIG. 7, the end-user 702 makes a request to a first web server 704 for content. The first web server 704 then makes a request for content to a second web server 706. The second web server 706 retrieves content from its files, runs the content analysis method as disclosed herein, and issues web content and advisories to the first web server 704. The first web server 704 then issues web content and advisories to the end-user 702 via one of the two methods described earlier.

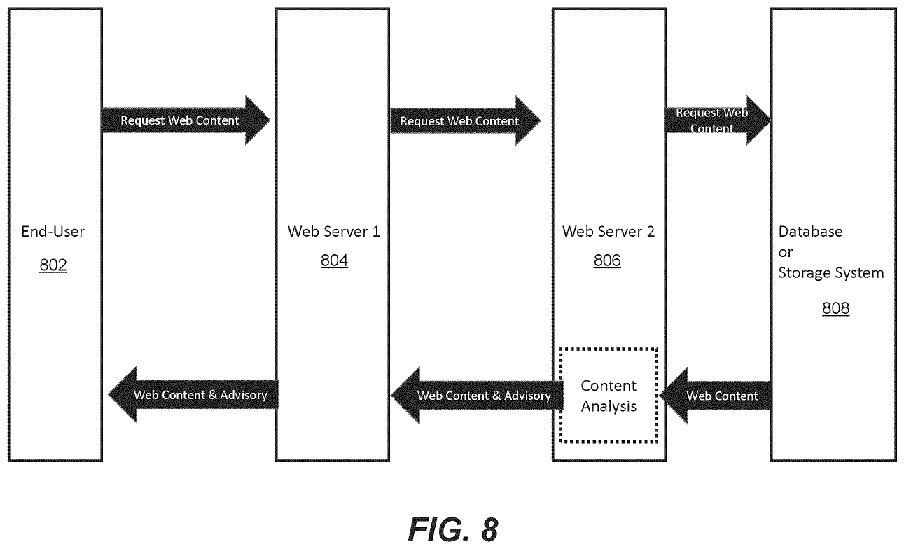

In the implementation shown in FIG. 8, the end-user 802 makes a request to a first web server 802 for content. The first web server 804 then makes a request for content to a second web server 806. The second web server 806 retrieves content from a database or storage system 808, runs the content analysis method as disclosed herein, and issues web content and advisories to the first web server 804. The first web server 804 then issues web content and advisories to the end-user 802 via one of the two methods described earlier.

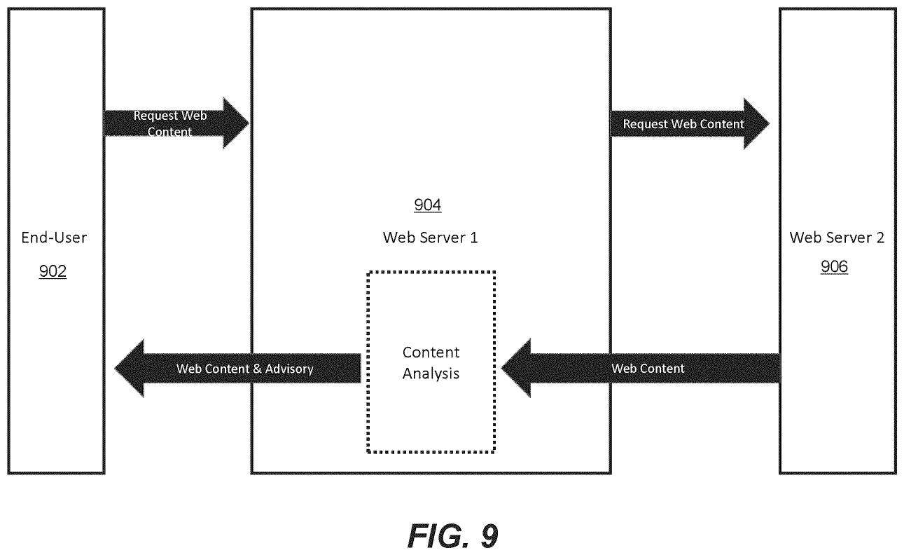

In the implementation shown in FIG. 9, the end-user 902 makes a request to a first web server 904 for content. The first web server 904 then makes a request for content to a second web server 906. The second web server 906 retrieves content from its files and passes it back to the web server 904. The first web server 904 runs the content analysis method as disclosed herein and issues web content and advisories to the end-user 902 via one of the two methods described earlier.

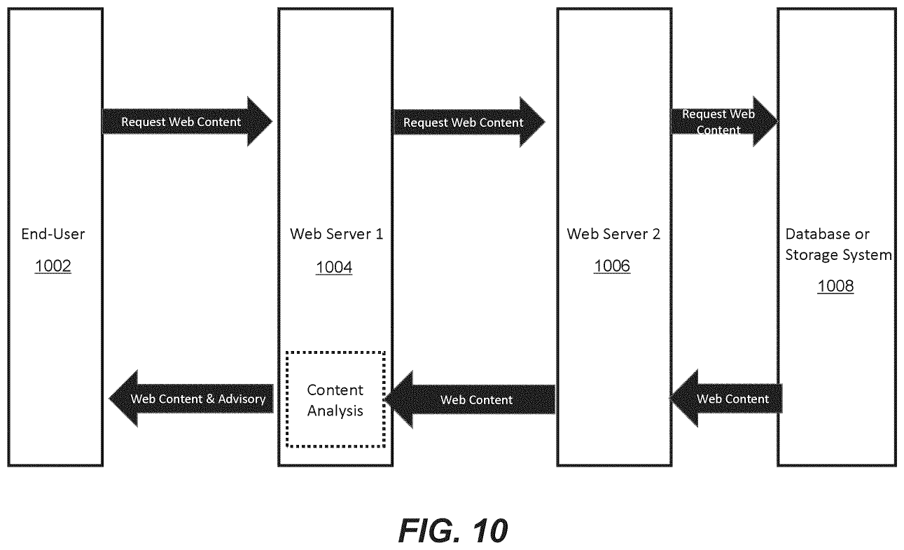

In the implementation shown in FIG. 10, the end-user 1002 makes a request to a first web server 1004 for content. The first web server 1004 then makes a request for content to a second web server 1006. The second web server 1006 then retrieves content from a database or storage system 1008 and passes it back to the first web server 1004. The first web server 1004 runs the content analysis method as disclosed herein and issues web content and advisories to the end-user 1002 via one of the two methods described earlier.

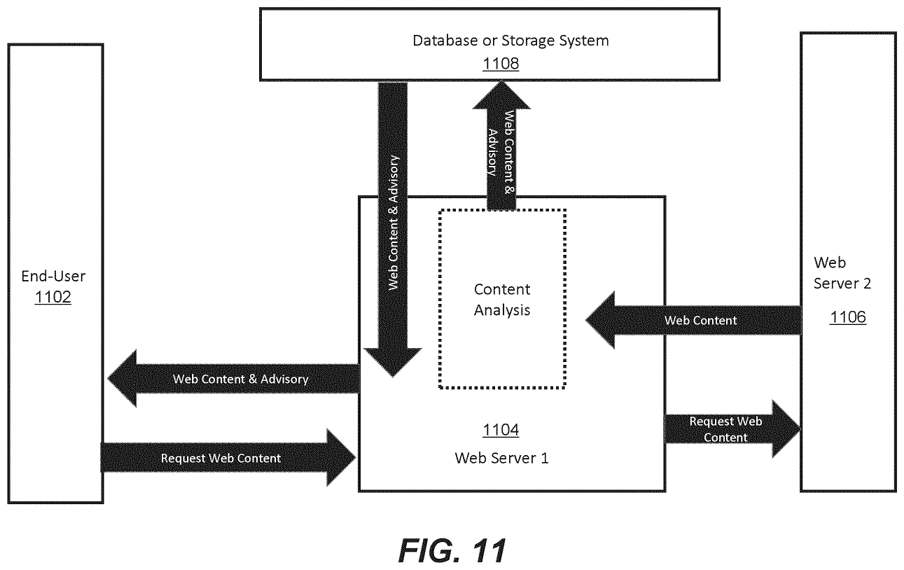

In the implementation shown in FIG. 11, a first web server 1104 makes a request for content to a second web server 1106. The second web server 1106 then passes this content back to the first web server 1104, which then runs the content analysis method as disclosed herein and stores both advisories and content in a database or storage system 1108. Then, when the end-user 1102 makes a request for content, the first web server 1104 retrieves the content and advisories from the database or storage system 1108, and issues them to the end-user 1102 via one of the two methods described earlier.

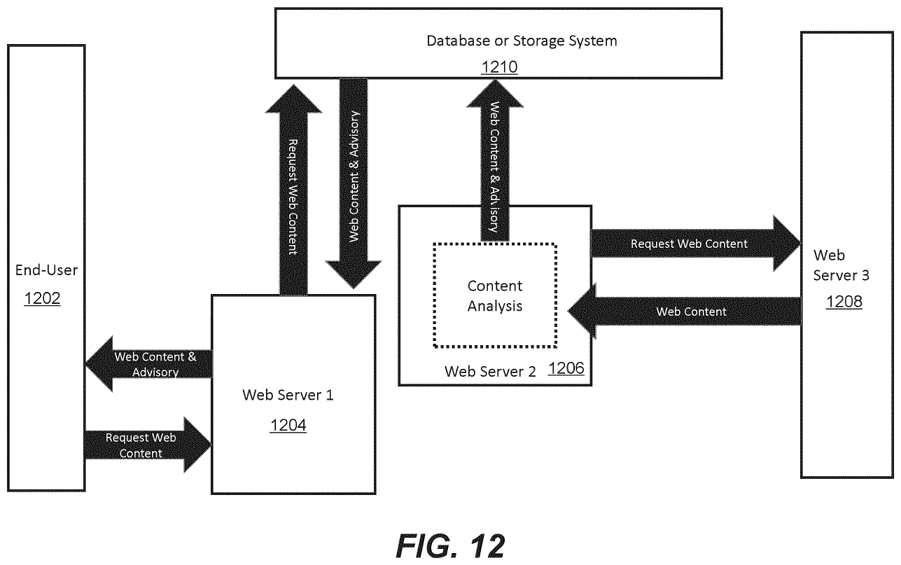

In the implementation shown in FIG. 12, a second web server 1206 makes a request for content to a third web server 1208. The third web server 1208 then passes this content back to the second web server 1206. The second web server 1206 then runs the content analysis method as disclosed herein and stores both advisories and content in a database or storage system 1210. Then, when the end-user 1202 makes a request for content to a first web server 1204, the web server 1204 retrieves the content and advisories from the database or storage system 1210, and issues them to the end-user 1202 via one of the two methods described earlier.

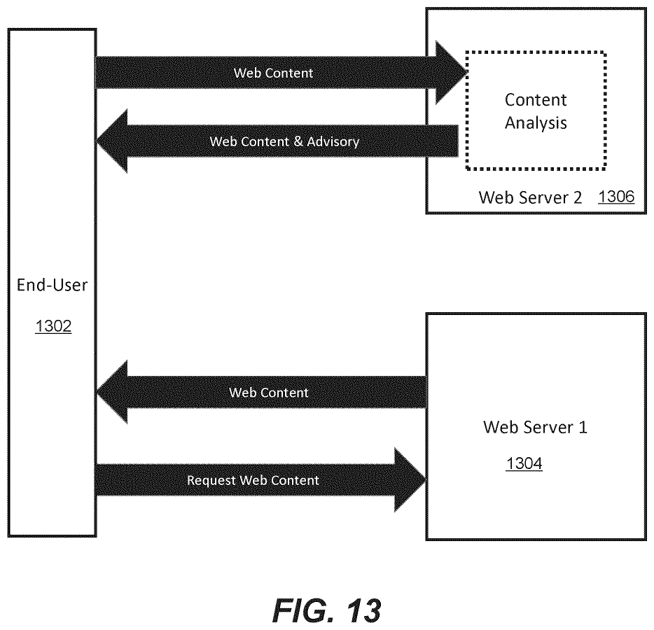

In the implementation shown in FIG. 13, the end-user 1302 makes a request to a first web server 1304 for content. The first web server 1304 then passes this content back to the end-user 1302; however, before the content is displayed to the end-user 1302, client-side technologies send the content to a second web server 1306. The second web server 1306 then runs the content analysis method as disclosed herein and issues web content and advisories to the end-user 1302 via one of the two methods described earlier.

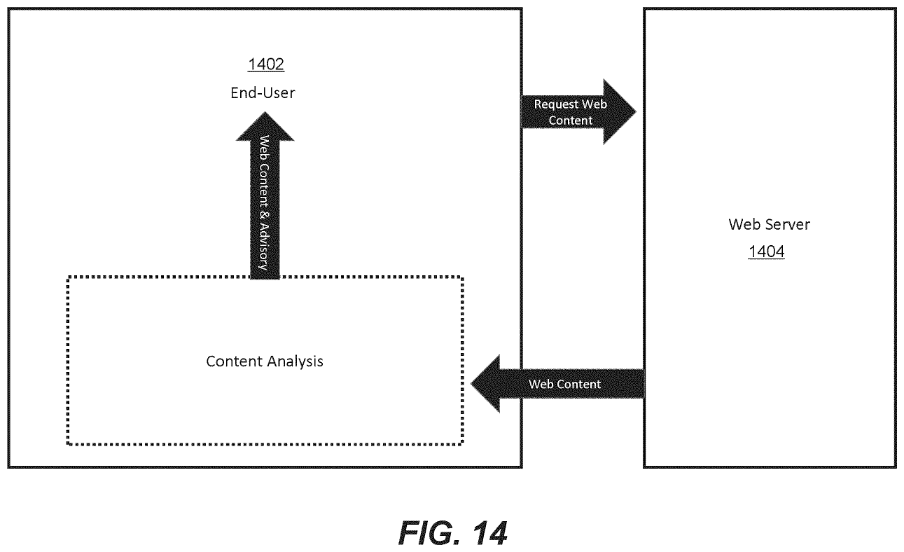

If the content analysis systems and methods are deployed as a client-side technology, there are a number of different ways it can be deployed, as shown in FIGS. 14 to 17.

In the implementation shown in FIG. 14, the end-user 1402 makes a request from a first web server 1404 for content. The first web server 1404 then passes this content back to the end-user 1402; however, before it is displayed, client-side technologies run the content analysis method as disclosed herein and either (1) displays advisories alongside the content, or (2) shows advisories first, then if the end-user selects the next/approve/etc. button, the advisories are removed and the content shown.

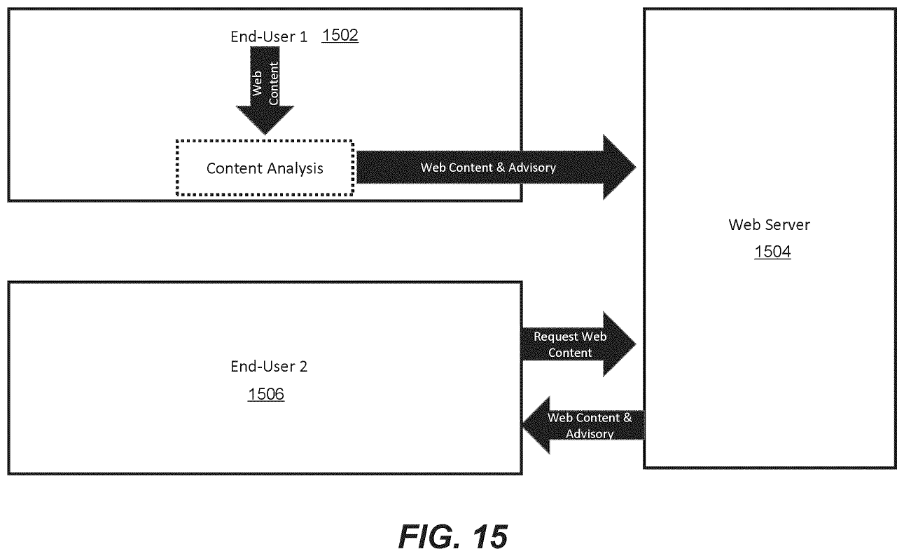

In the implementation shown in FIG. 15, before a first end-user 1502 submits content to a web server 1504, client-side technologies run the content analysis method as disclosed herein and then pass both the content and advisories to the web server 1504. Then, when a second end-user 1506 requests the content submitted by the first end-user 1502, the web server 1504 issues the web content and advisories to the second end-user 1506.

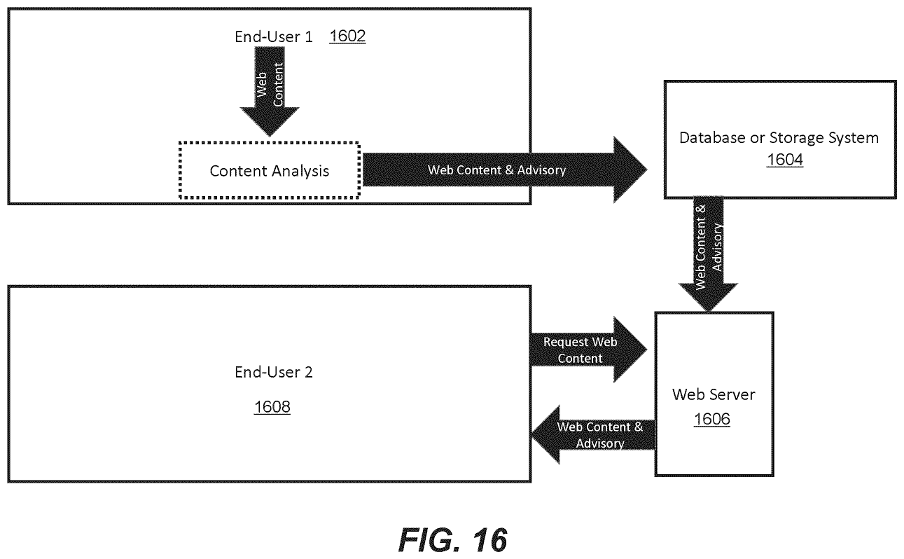

In the implementation shown in FIG. 16, before a first end-user 1602 submits content to a database or storage system 1604, client-side technologies run the content analysis method as disclosed herein and then pass both the content and advisories to the database or storage system 1604. Then, when a second end-user 1608 requests the content submitted by the first end-user 1602, the web server 1606 retrieves the content and advisories and issues them to the second end-user 1608.

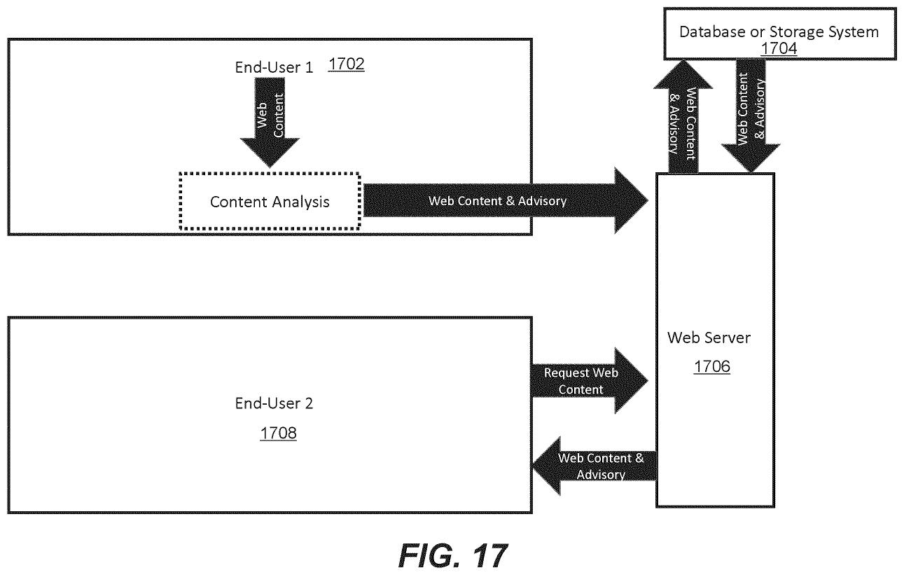

In the implementation shown in FIG. 17, before a first end-user 1702 submits content to a web server 1706, client-side technologies run the content analysis method as disclosed herein and then pass both the content and advisories to the web server 1706. The web server 1706 then stores the web content and advisories in a database or storage system 1704. Then, when a second end-user 1708 requests the content submitted by the first end-user 1702, the web server 1706 retrieves the web content and advisory from the database or storage system 1704 and issues them to the second end-user 1708.

It would be appreciated by one of ordinary skill in the art that the system and components shown in the figures may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as described herein.

1. A content analysis method, comprising:
receiving content;
computing a rhetoric vector by analyzing a language structure of the content, the rhetoric vector comprising one or more dimensions each representative of a rhetoric aspect of the language structure; and
classifying the rhetoric vector with a trained classifier to determine whether a content advisory should be associated with the content.

2. The method of claim 1, wherein computing the rhetoric vector comprises computing each dimension, at least partly, using one or more language structure metrics including a distance metric, a proportion metric, and a count metric.

3. The method of claim 1, wherein computing the rhetoric vector further comprises computing a word count in the content.

4. The method of claim 1, further comprising computing a plurality of dimensions of the rhetoric vector.

5. The method of claim 1, further comprising preprocessing the content, wherein preprocessing the content comprises one or both of: extracting the content from extraneous content, and generating cleaned text from the content.

6. The method of claim 1, wherein the content is received in a textual format, and the trained classifier is trained for the textual content.

7. The method of claim 1, wherein the content is received in an audio or video format, and the method further comprises converting the format to a textual format and analyzing the language structure of the textual format of the content.

8. The method of claim 7, wherein the trained classifier is trained for audio or video content.

9. The method of claim 1, further comprising generating a content advisory for the content based on one or more dimensions of the rhetoric vector.

10. The method of claim 1, further comprising associating a content advisory to the content based on one or more dimensions of the rhetoric vector.

11. The method of claim 9, further comprising outputting the content advisory to a content consumer.

12. The method of claim 11, wherein the content advisory is output to the content consumer concurrently with the content or prior to giving access to the content to the content consumer.

13. The method of claim 11, wherein the content advisory is output to the content consumer in association with a web search result returning the content.

14. The method of claim 1, further comprising ranking a webpage containing the content using one or both of the rhetoric vector and a classification of the rhetoric vector by the trained classifier.

15. The method of claim 1, further comprising adjusting a pay-per-click cost associated with the content based on one or both of the rhetoric vector and a classification of the rhetoric vector by the trained classifier.

16. The method of claim 1, wherein the method is performed at a server providing access to the content.

17. The method of claim 1, wherein the method is performed at a user device attempting to access to the content.

18. A content analysis system, comprising:
a processor; and
a non-transitory computer-readable memory having computer-executable instructions stored thereon, which when executed by the processor, configure the content analysis system to perform the method of claim 1.

19. The content analysis system of claim 18, further comprising a database for storing the content in association with the content advisory when generated.

20. A non-transitory computer-readable memory having computer-executable instructions stored thereon, which when executed by a processor, configure the processor to perform the method of claim 1.
